(19) United States
(12) Patent Application Publication
(10) Pub. No.: US 2022/0287029 A1
(43) Pub. Date: Sep. 8, 2022

(54) UCI TRANSMISSION AND RECEPTION METHODS, DEVICE, SYSTEM, APPARATUS, AND MEDIUM

(71) Applicant: DATANG MOBILE COMMUNICATIONS EQUIPMENT CO., LTD., Beijing (CN)

(72) Inventor: Xuejuan GAO, Beijing (CN)

(21) Appl. No.: 17/630,121

(22) PCT Filed: Jul. 13, 2020
(86) PCT No.: PCT/CN2020/101724

§ 371 Date: Jan. 25, 2022

(30) Foreign Application Priority Data
Jul. 25, 2019 (CN) 201910678442.4

(51) Int. Cl. H04W 72/04

(52) U.S. Cl. CPC H04W 72/0413; H04W 72/0446

(57) ABSTRACT

The present application discloses UCI transmission and reception methods, a device, a system, an apparatus, and a medium that can resolve the issue of how to perform UCI transmission when a plurality of PUCCHs carrying HARQ-ACK are present in a slot. The UCI transmission method comprises: a terminal receiving configuration information; determining, according to the configuration information, a PUCCH resource corresponding to UCI, wherein the PUCCH resource is in a sub-slot; and performing UCI transmission on the basis of the PUCCH resource corresponding to the UCI. In the embodiments of the application, the terminal determines, according to the received configuration information, the PUCCH resource corresponding to the UCI in a sub-slot, and performs UCI transmission on the basis of the determined PUCCH resource, thereby achieving UCI transmission in Rel-16, and preventing an overlap of PUCCHs carrying HARQ-ACK and PUCCHs carrying CSI/SR in a TDM scheme.

### CROSS-REFERENCE TO RELATED APPLICATIONS

The present application is a National Stage of International Application No. PCT/CN2020/101724, filed on Jul. 13, 2020, which claims priority to the Chinese Patent Application No. 201910678442.4, filed to China National Intellectual Property Administration on Jul. 25, 2019, both of which are incorporated herein by reference.

### FIELD

The present disclosure relates to the field of communication, in particular to methods for receiving uplink control information (UCI) and apparatuses thereof, a system, a device and a medium.

### BACKGROUND

With rapid development of communication technology, 5G new radio (NR) has entered people's life. While the new technology brings many delightful changes, it makes many previously defined standards not applicable any more. In 5G NR, Rel-16 will support the transmission of multiple time-division multiplexed physical uplink control channels (PUCCHs) in one slot carrying hybrid automatic repeat request-acknowledgement (HARQ-ACK).

Currently, in an NR system, a total of 5 PUCCH formats, namely 0, 1, 2, 3, and 4, are defined as NR formats. The PUCCH formats 0 and 1 can carry UCI transmission of 1 to 2 bits, and the PUCCH formats 2, 3 and 4 can carry UCI transmission of more than 2 bits. The HARQ-ACK can use any one of the 5 PUCCH formats. A scheduling request (SR) may be sent by using the PUCCH format 0 or 1, and a used PUCCH resource is configured by a high-level signaling. Channel state information (CSI) may be sent by using the PUCCH format 2, 3 or 4, and a used PUCCH resource is configured by a high-level signaling.

An NR R15 system only supports transmission of at most one PUCCH carrying HARQ-ACK in one slot. When a PUCCH carrying CSI/SR overlaps with the one PUCCH carrying the HARQ-ACK, a corresponding manner will be adopted for multiplexing transmission according to formats of the PUCCH carrying CSI/SR and the PUCCH carrying the HARQ-ACK.

When there are PUCCHs in the one slot, and there is an overlap between the PUCCHs, that the PUCCHs in one slot constitute constitutes a set Q is assumed: an uplink channel with the earliest start time in the set Q is determined as a channel A, and a channel set X that overlaps with the channel A is determined; for UCI on the channel A and a channel X, multiplexing transmission is performed in accordance with the above multiplexing transmission rules to obtain a channel resource for multiplexing transmission, and this multiplexing transmission channel resource is used to replace the channel A and the channel X in the set Q; and the above steps are repeated to determine a channel A and a channel X in a new Q set, and so on, until PUCCHs that do not overlap with each other in time domain are obtained.

The above-mentioned UCI transmission method is established on the NR R15 system. The NR R15 system only supports transmission of at most one PUCCH carrying the HARQ-ACK in one slot. In case of an overlap between the PUCCHs, only a situation exits that one PUCCH resource of the HARQ-ACK overlaps with a PUCCH resource of the CSI/SR, so only how to perform UCI multiplexing transmission when the one PUCCH carrying the CSI/SR overlaps with the PUCCH carrying the HARQ-ACK is defined.

Therefore, when there are PUCCHs carrying the HARQ-ACK in one slot, there is no specified method for how to perform UCI transmission.

### SUMMARY

Embodiments of the present disclosure provide methods for sending and receiving UCI and apparatus thereof, a system, a device and a medium, configured to solve the problem of how to perform UCI transmission when PUCCHs carrying HARQ-ACK exist in one slot.

An embodiment of the present disclosure provides a method for sending UCI, including: receiving, by a terminal, configuration information; determining, by the terminal, according to the configuration information, a PUCCH resource corresponding to UCI, and the PUCCH resource is in one sub-slot; and sending, by the terminal, the UCI according to the PUCCH resource corresponding to the UCI.

An embodiment of the present disclosure further provides a method for receiving UCI, including: sending, by a base station, configuration information, and the configuration information is configured to indicate a PUCCH resource corresponding to UCI, and the PUCCH resource is in one sub-slot; and receiving, by the base station, the UCI according to the PUCCH resource corresponding to the UCI.

An embodiment of the present disclosure provides an for sending UCI, including: a receiving device, configured to receive configuration information; a determining device, configured to determine a PUCCH resource corresponding to UCI according to the configuration information, and the PUCCH resource is in one sub-slot; and a sending device, configured to send the UCI according to the PUCCH resource corresponding to the UCI.

The above devices are all applied to a terminal. The terminal includes: a processor, a memory and a transceiver.

The transceiver is configured to receive configuration information.

The processor is configured to read a program in the memory to determine, according to the configuration information, a PUCCH resource corresponding to UCI, and the PUCCH resource is in one sub-slot; and control the transceiver to perform UCI transmission according to the PUCCH resource corresponding to the UCI.

The transceiver is further configured to send the UCI according to the PUCCH resource corresponding to the UCI.

Base on the same inventive concept, an embodiment of the present disclosure further provides an apparatus for receiving UCI, including: a sending device, configured to send configuration information, and the configuration information is configured to indicate a PUCCH resource corresponding to UCI, and the PUCCH resource is in one sub-slot; and a receiving device, configured to receive the UCI according to the PUCCH resource corresponding to the UCI.

The devices are all applied to a base station. The base station includes: a processor, a memory and a transceiver.

The processor is configured to read a program in the memory to: control the transceiver to send configuration information, and the configuration information is configured to indicate a PUCCH resource corresponding to UCI, and the PUCCH resource is in one sub-slot; and control the transceiver to receive the UCI according to the PUCCH resource corresponding to the UCI; and the transceiver is configured to send the configuration information and receive the UCI according to the PUCCH resource corresponding to the UCI.

An embodiment of the present disclosure provides a computer readable storage medium, storing a computer program executable by a terminal. When the program is run on the terminal, the terminal executes steps of any one of the above-mentioned method for sending the UCI.

An embodiment of the present disclosure further provides a computer readable storage medium, storing a computer program executable by a base station. When the program is run on the base station, the base station executes steps of any one of the above-mentioned method for receiving the UCI.

An embodiment of the present disclosure further provides a UCI transmission system, including an electronic device applied to the terminal according to any one of the above-mentioned method for sending the UCI, and an electronic device applied to the base station according to any one of the above-mentioned method for receiving UCI.

Because in the embodiments of the present disclosure, the terminal determines a PUCCH resource corresponding to UCI in a sub-slot according to the received configuration information, and sending the UCI according to the determined PUCCH resource, UCI transmission is achieved in Rel-16, to prevent an overlap between PUCCHs carrying HARQ-ACK and PUCCHs carrying CSI/SR in a TDM scheme.

### BRIEF DESCRIPTION OF THE DRAWINGS

FIG. 1 is a schematic diagram of a UCI transmission method with multiple channels overlapping in the prior art.

FIG. 2 is a schematic diagram of a UCI transmission method with multiple channels overlapping in the prior art.

FIG. 3 is a flow chart of a Method for sending UCI provided by an embodiment of the present disclosure.

FIG. 4 is a flow chart of a method for receiving UCI provided by an embodiment of the present disclosure.

FIG. 5 is a schematic diagram of a UCI transmission method provided by an embodiment of the present disclosure described in some embodiments.

FIG. 6 is a schematic diagram of a UCI transmission method provided by an embodiment of the present disclosure described in some embodiments.

FIG. 7 is a schematic diagram of a UCI transmission method provided by an embodiment of the present disclosure described in some embodiments.

FIG. 8 is a schematic diagram of a UCI transmission method provided by an embodiment of the present disclosure described in some embodiments.

FIG. 9 is a schematic diagram of a UCI transmission method provided by an embodiment of the present disclosure described in some embodiments.

FIG. 10 is a schematic structural diagram of an apparatus for sending UCI provided by an embodiment of the present disclosure.

FIG. 11 is a schematic structural diagram of an apparatus for receiving provided by an embodiment of the present disclosure.

FIG. 12 is a schematic structural diagram of a terminal further provided by an embodiment of the present disclosure.

FIG. 13 is a schematic structural diagram of a base station further provided by an embodiment of the present disclosure.

FIG. 14 is a schematic structural diagram of a UCI transmission system provided by an embodiment of the present disclosure.

### DETAILED DESCRIPTION OF THE EMBODIMENTS

Embodiments of the present disclosure will be further described in detail in conjunction with the accompanying drawings. The described embodiments are part of the embodiments of the present disclosure, rather than all of the embodiments.

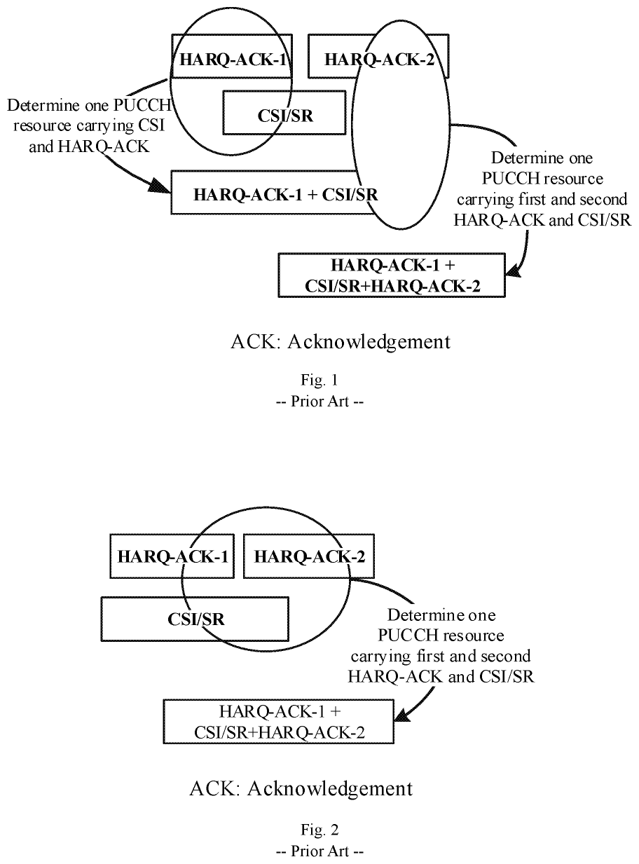

Rel-16 supports the transmission of multiple time-division multiplexed PUCCHs carrying HARQ-ACK. At the moment, the PUCCHs carrying the HARQ-ACK are sent in one sub-slot in one slot. Because the slot may contain sub-slots, every sub-slot may transmit a PUCCH carrying the HARQ-ACK. When CSI and SR are still sent following a Rel-15 transmission mechanism, PUCCH resources of the CSI and the SR may occupy any symbol in the slot, so there may be an overlap between the multiple PUCCHs carrying the HARQ-ACK and a PUCCH carrying the SR/CSI. Should multiplexing transmission rules in R15 be adopted, specifically as shown in FIGS. 1 and 2, if two sub-slots transmit the PUCCHs carrying the HARQ-ACK and a PUCCH resource carrying the CSI/SR occupies a part of symbols in a first sub-slot and occupies a part of symbols in a second sub-slot, when multiplexing transmission is performed, a first overlap may be processed first, i.e. an overlap between a PUCCH carrying HARQ-ACK-1 and the PUCCH resource carrying the CSI/SR in the first sub-slot. According to the multiplexing transmission rules, a PUCCH resource for simultaneously carrying the CSI/SR and the HARQ-ACK may be determined, i.e. HARQ-ACK-1+CSI/SR, and this PUCCH resource may overlap with a PUCCH carrying a second HARQ-ACK. When this PUCCH resource overlaps with the PUCCH carrying the second HARQ-ACK, to further process the overlap, a PUCCH resource for simultaneously carrying the first and the second HARQ-ACK as well as the CSI/SR needs to be further determined, i.e. HARQ-ACK-1+CSI/SR+HARQ-ACK-2. Or, the overlaps among the three PUCCHs may be directly processed, for example, the PUCCH resource for simultaneously carrying the first and the second HARQ-ACK as well as the CSI/SR is directly determined, i.e. HARQ-ACK-1+CSI/SR+HARQ-ACK-2.

Adopting the multiplexing transmission rules in R15 may result in that transmission of HARQ-ACKs which do not originally overlap in time domain resource need to be multiplexed in one same PUCCH for simultaneous transmission, because the transmission of HARQ-ACKs overlaps with the CSI/SR in time domain, which will affect the transmission performance of the HARQ-ACKs. On the one hand, two HARQ-ACKs are sent on one same PUCCH, and at least one of the HARQ-ACKs needs to be transferred, or the two HARQ-ACKs may need to be transferred. If a transferred resource is longer in transmission time or later in start moment compared with an original resource, it will result in an increase of time delay of the HARQ-ACKs subjected to multiplexing transmission compared with original HARQ-ACK transmission. If a code rate of a PUCCH carrying both HARQ-ACKs is increased compared with a code rate of PUCCH for originally transmitting a single HARQ-ACK, it will result in that the transmission performance of the HARQ-ACKs subjected to multiplexing transmission is reduced compared with original HARQ-ACK transmission.

Embodiments of the present disclosure provide a method for sending or receiving UCI and apparatus thereof, a system, a device and a medium, configured to solve the problem of how to perform UCI transmission when PUCCHs carrying HARQ-ACK exist in one slot.

### Embodiment 1

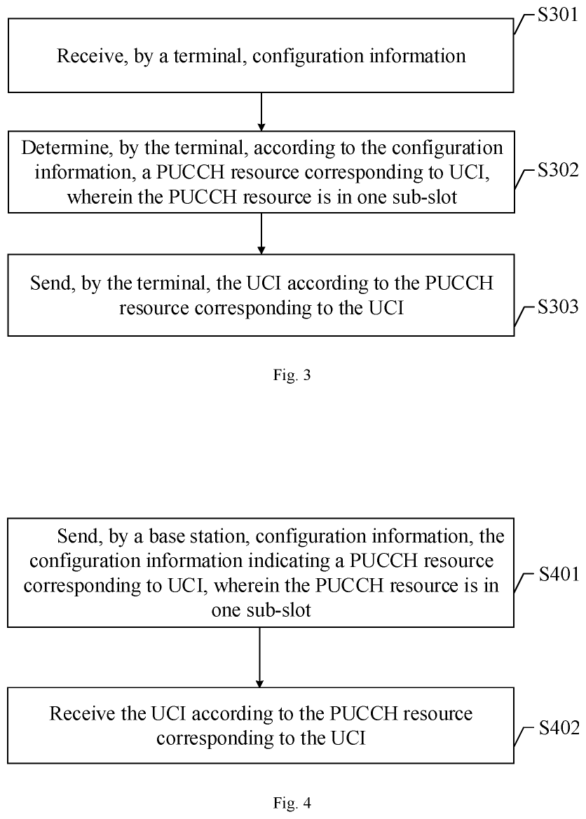

FIG. 3 is a method for sending UCI provided by an embodiment of the present disclosure. The method includes the following steps.

S301: a terminal receives configuration information.

The method for sending the UCI provided by the embodiment of the present disclosure is applied to the terminal. The terminal receives the configuration information sent by a network side device, and the network side device may be a base station.

The configuration information is a high-layer signaling, downlink control information (DCI), or a media access control (MAC) control element (CE), which is not specifically limited in the embodiment of the present disclosure. The base station and the terminal may be agreed in advance, or be configured through a protocol.

S302: a PUCCH resource corresponding to UCI is determined according to the configuration information. The PUCCH resource is in one sub-slot.

The UCI includes: at least one of HARQ-ACK, CSI or SR. In particular, the UCI may include only the HARQ-ACK, the CSI or the SR. Because the embodiment of the present disclosure solves the problem of how to perform UCI transmission when there is an overlap in time domain between PUCCHs carrying HARQ-ACK and PUCCHs carrying SR/CSI, situations may exit that the UCI includes the HARQ-ACK and the CSI at the same time, or includes the HARQ-ACK and the SR at the same time, or includes the CSI and the SR at the same time, or includes the HARQ-ACK, the CSI and the SR at the same time.

In the embodiment of the present disclosure, the one sub-slot is a pre-defined or configured time unit with a fixed quantity of symbols in one slot, and an order of sub-slots within the one slot, a position of each sub-slot, and a quantity of symbols contained in each sub-slot are pre-defined or configured.

The quantities of symbols contained in different sub-slots within the one slot are equal, or unequal. In other words, in all sub-slots contained in the one same slot, the quantities of symbols contained in the respective sub-slots may be equal, for example, there are 7 sub-slots each containing 2 symbols, and of course, the quantities of the symbols contained in the respective sub-slots may be different, for example, a first sub-slot contains 4 symbols, and a second sub-slot contains 3 symbols, but the specific quantities of the symbols may be determined through advance agreement or configuration.

In the embodiment of the present disclosure, the PUCCH resource being in the one sub-slot includes: the PUCCH resource does not cross a boundary of one sub-slot; or a start symbol and an end symbol of the PUCCH resource are in the one same sub-slot; or a quantity of symbols of the PUCCH resource does not exceed a quantity of symbols contained in one sub-slot.

In the condition that different sub-slots contain different quantities of symbols, the quantity of the symbols of the PUCCH resource does not exceed the quantity of symbols contained in a sub-slot containing the largest quantity of symbols.

S303: the UCI is sent according to the PUCCH resource corresponding to the UCI.

After the PUCCH resource corresponding to the UCI is determined, the UCI may be sent according to the PUCCH resource. For a specific process of performing UCI transmission according to the PUCCH resource, determination of the specific transmission process based on description of the embodiment of the present disclosure, which will not be repeated here.

In the embodiment of the present disclosure, the terminal determines the PUCCH resource corresponding to the UCI in one sub-slot according to the received configuration information, and performs transmission of the UCI according to the determined PUCCH resource, so UCI transmission is achieved in Rel-16, to prevent an overlap between PUCCHs carrying HARQ-ACK and PUCCHs carrying CSI/SR in a TDM scheme.

### Embodiment 2

To achieve UCI transmission in Rel-16, according to the above embodiment, in the embodiment of the present disclosure, sending the UCI according to a PUCCH resource corresponding to UCI includes the following.

In the condition that the PUCCH resource corresponding to the UCI does not overlap with and other uplink channels in time domain, the UCI is sent on the PUCCH resource corresponding to the UCI.

That is, the PUCCH resource corresponding to the UCI does not overlap with the other uplink channels in time domain, multiplexing transmission does not exit, so the UCI may be directly sent on the PUCCH resource corresponding to the UCI.

The sending the UCI according to the PUCCH resource corresponding to the UCI includes the following.

For any one sub-slot, in the condition that a PUCCH resource corresponding to first UCI in the any one sub-slot overlaps in at least one symbol with a PUCCH resource corresponding to second UCI, a PUCCH resource for sending the first UCI and the second UCI is determined, and the PUCCH resource for sending the first UCI and the second UCI is in one sub-slot; and the first UCI and the second UCI are sent on the determined PUCCH resource.

That is, in a sub-slot n, in the condition that a PUCCH resource corresponding to one kind of UCI overlaps in at least one symbol with a PUCCH resource corresponding to other UCI, a PUCCH resource for simultaneously sending the UCI and the other UCI is determined, and the PUCCH resource for simultaneously sending the UCI and the other UCI is in the sub-slot n as well, and it is ensured that when the UCI and the other UCI are sent on the determined PUCCH resource, there will be no overlap with a PUCCH in other sub-slots.

Specifically, when one kind of UCI is CSI/SR, and the other kind of UCI is HARQ-ACK, and a PUCCH carrying the CSI/SR overlaps with a PUCCH carrying the HARQ-ACK, multiplexing transmission may be performed according to the following method (i.e. the PUCCH resource for simultaneously sending the UCI and the other UCI is determined according to the following method).

When the PUCCH carrying the SR overlaps with the PUCCH carrying the HARQ-ACK, and the PUCCH carrying the HARQ-ACK uses a PUCCH format 0 (the PUCCH carrying the SR may use the format 0 and may also use a format 1), multiplexing transmission of the SR and the HARQ-ACK is performed on the PUCCH resource of the HARQ-ACK, i.e. through using different cyclic shifts (CSs) for transmitting the HARQ-ACK on the PUCCH resource of the HARQ-ACK, whether the SR is positive or negative is implicitly expressed; and in other words, at the moment, the PUCCH resource for simultaneously transmitting the SR and the HARQ-ACK is determined as the PUCCH resource corresponding to the HARQ-ACK.

When the PUCCH carrying the SR overlaps with the PUCCH carrying the HARQ-ACK, the PUCCH carrying the SR uses the format 0, and the PUCCH carrying the HARQ-ACK uses the format 1, the SR is discarded; and in other words, multiplexing transmission is not performed at the moment.

When the PUCCH carrying the SR overlaps with the PUCCH carrying the HARQ-ACK, the PUCCH carrying the SR uses the format 1, and the PUCCH carrying the HARQ-ACK uses the format 1, and when positive SR exists, the HARQ-ACK is sent on the PUCCH resource of the SR, so simultaneous existence of SR transmission is implicitly expressed; otherwise, negative SR exists, and the HARQ-ACK is sent on the PUCCH resource of the HARQ-ACK. In other words, at the moment, the PUCCH resource for simultaneously transmitting the SR and the HARQ-ACK is determined as the PUCCH resource corresponding to the SR.

When the PUCCH carrying the SR overlaps with the PUCCH carrying the HARQ-ACK, and the PUCCH carrying the HARQ-ACK uses a PUCCH format 2/3/4 (the PUCCH carrying the SR may use the format 0 and may also use the format 1), a PUCCH resource set is determined according to the total quantity of bits of the SR and the HARQ-ACK. According to a PUCCH resource indication field in DCI corresponding to the HARQ-ACK, one PUCCH resource for simultaneous transmission of the SR and the HARQ-ACK is determined in the determined PUCCH resource set, where the SR is of X bits, SR state in SRs overlapping with the HARQ-ACK is expressed (expressing positive ones, or expressing that all SRs are negative), and regardless of whether the SRs are positive or negative, X bits of the SR is sent, to avoid that the SR state causes a change of UCI bits sent on the PUCCH resource of the HARQ-ACK. In other words, at the moment, the PUCCH resource for simultaneously transmitting the SR and the HARQ-ACK is determined as a PUCCH resource determined according to the total quantity of bits of the SR and the HARQ-ACK, and the PUCCH resource may be the same as or different from (i.e. a new PUCCH resource) the original PUCCH resource carrying the HARQ-ACK.

When a PUCCH carrying SPS HARQ-ACK (i.e. HARQ-ACK corresponding to SPS PDSCH) overlaps with the PUCCH carrying the CSI, the SPS HARQ-ACK is transferred to the PUCCH resource corresponding to the CSI for multiplexing transmission with the CSI. In other words, a PUCCH resource for simultaneously transmitting the CSI and the HARQ-ACK is determined as the PUCCH resource corresponding to the CSI.

When a PUCCH carrying dynamic HARQ-ACK (i.e. HARQ-ACK corresponding to PDSCH having corresponding DCI scheduling or corresponding to DCI indicating release of downlink SPS PDSCH) overlaps with the PUCCH carrying the CSI, a PUCCH resource set is selected from PUCCH resource sets according to the total number of bits of the HARQ-ACK and the CSI. According to a PUCCH resource indication field in the DCI corresponding to the HARQ-ACK, a PUCCH resource for simultaneously carrying the HARQ-ACK and the CSI is determined from the selected PUCCH resource set. In other words, the PUCCH resource for simultaneously transmitting the CSI and the HARQ-ACK is determined as a PUCCH resource determined based on the total number of bits of the CSI and the HARQ-ACK, and the PUCCH resource may be the same as or different from (i.e. the PUCCH resource is a new PUCCH resource) the original PUCCH resource carrying the HARQ-ACK.

If there is an overlap among the HARQ-ACK, the SR and the CSI at the same time, the above solution is combined.

When the kind of the UCI is CSI, the other kind of UCI is the SR, and the PUCCH carrying the CSI overlaps with the PUCCH carrying the SR, multiplexing transmission may be performed according to the following method (i.e. the PUCCH resource for simultaneously transmitting the UCI and the other UCI is determined according to the following method).

When the PUCCH carrying the SR overlaps with the PUCCH carrying the CSI, the SR is transferred to the PUCCH resource corresponding to the CSI for multiplexing transmission with the CSI; and in other words, the PUCCH resource for simultaneously transmitting the CSI and the SR is determined as the PUCCH resource corresponding to the CSI.

In the embodiment of the present disclosure, for any one sub-slot, in the condition that a PUCCH resource corresponding to first UCI in the any one sub-slot overlaps in at least one symbol with a PUCCH resource corresponding to second UCI, a PUCCH resource for simultaneously transmitting the first UCI and the second UCI is determined according to the above method, provided that the determined PUCCH resource for simultaneously transmitting the first UCI and the second UCI should be in the sub-slot, and the first UCI and the second UCI are sent on the determined PUCCH resource.

### Embodiment 3

FIG. 4 is a method for receiving UCI provided by an embodiment of the present disclosure. The method includes the following.

S401, a base station sends configuration information. The configuration information indicates a PUCCH resource corresponding to UCI, and the PUCCH resource is in one sub-slot.

The method for receiving the UCI provided by the embodiment of the present disclosure is applied to the base station. The base station sends the configuration information to a terminal side, and the configuration information is a high-level signaling, or DCI, or MACCE, which is not specifically limited in the embodiment of the present disclosure.

Correspondingly, the UCI includes: at least one of HARQ-ACK, CSI or SR.

Further, one sub-slot is a pre-defined or configured time unit with a fixed quantity of symbols in one slot, and an order of sub-slots within the one slot, a position of each sub-slot, and a quantity of symbols contained in each sub-slot are pre-defined or configured.

The quantities of symbols contained in different sub-slots within the slot are equal, or unequal.

In one embodiment, the PUCCH resource being in the one sub-slot includes: the PUCCH resource does not cross a boundary of one sub-slot; or a start symbol and an end symbol of the PUCCH resource are in the one same sub-slot; or a quantity of symbols of the PUCCH resource does not exceed the quantity of symbols contained in one sub-slot.

In the condition that different sub-slots contain different quantities of symbols, the quantity of the symbols of the PUCCH resource does not exceed the quantity of symbols contained in a sub-slot with the largest quantity of symbols.

S402, the UCI is received according to the PUCCH resource corresponding to the UCI.

After the PUCCH resource corresponding to the UCI is determined, the UCI may be received according to the PUCCH resource. For a specific process of performing UCI reception according to the PUCCH resource, determination of the specific reception process based on description of the embodiment of the present disclosure, which will not be repeated here.

In the embodiment of the present disclosure, the base station determines the PUCCH resource corresponding to the UCI in the sub-slot according to the configuration information, and performs reception of the UCI according to the determined PUCCH resource, so UCI reception is achieved in Rel-16, to prevent an overlap between PUCCHs carrying HARQ-ACK and PUCCHs carrying CSI/SR in a TDM scheme.

### Embodiment 4

To achieve UCI reception in Rel-16, according to the above embodiment, in the embodiment of the present disclosure, receiving the UCI according to a PUCCH resource corresponding to UCI includes the following.

In the condition that the PUCCH resource corresponding to the UCI does not overlap with other uplink channels in time domain, the UCI is received on the PUCCH resource corresponding to the UCI.

That is, in the condition that the PUCCH resource corresponding to the UCI does not overlap with the other uplink channels in time domain, multiplexing transmission does not exit, so the UCI may be directly received on the PUCCH resource corresponding to the UCI.

The receiving the UCI according to the PUCCH resource corresponding to the UCI includes the following.

For any one sub-slot, in the condition that a PUCCH resource corresponding to first UCI in the any one sub-slot overlaps in at least one symbol a PUCCH resource corresponding to second UCI, a PUCCH resource for receiving the first UCI and the second UCI is determined, and the PUCCH resource for receiving the first UCI and the second UCI is in one sub-slot; and the first UCI and the second UCI are received on the determined PUCCH resource.

That is, in a sub-slot n, in the condition that a PUCCH resource corresponding to one kind of UCI overlaps with a PUCCH resource corresponding to other UCI in at least one symbol, a PUCCH resource for simultaneously receiving the UCI and the other UCI is determined, and the PUCCH resource for simultaneously receiving the UCI and the other UCI is in the sub-slot n as well, and it is ensured that when the UCI and the other UCI are received on the determined PUCCH resource, there will be no overlap with a PUCCH in other sub-slots.

A process for sending and receiving the UCI provided by the embodiment of the present disclosure is described through specific embodiments below.

Assuming that two sub-slots are defined in a slot, and that each sub-slot corresponds to 7 symbols, when a base station configures a PUCCH resource corresponding to CSI and SR to a terminal, the determined PUCCH resource is in one sub-slot. For example, a PUCCH resource occupying 4 symbols for transmitting the SR is configured in the first sub-slot, and a PUCCH resource occupying 7 symbols for transmitting the CSI is configured in the second sub-slot, which is informed of to the terminal through configuration information; and the terminal may determine that the PUCCH resources corresponding to the SR and the CSI do not cross a boundary of the sub-slot. Such configuration may ensure that, if a PUCCH carrying HARQ-ACK exists in each sub-slot, the PUCCH resource of the SR does not simultaneously overlap with the two PUCCH resources transmitting the HARQ-ACK in a TDM scheme.

For example, in the first sub-slot, the SR overlaps with the HARQ-ACK in time domain resource, and a multiplexing transmission mechanism is adopted by following.

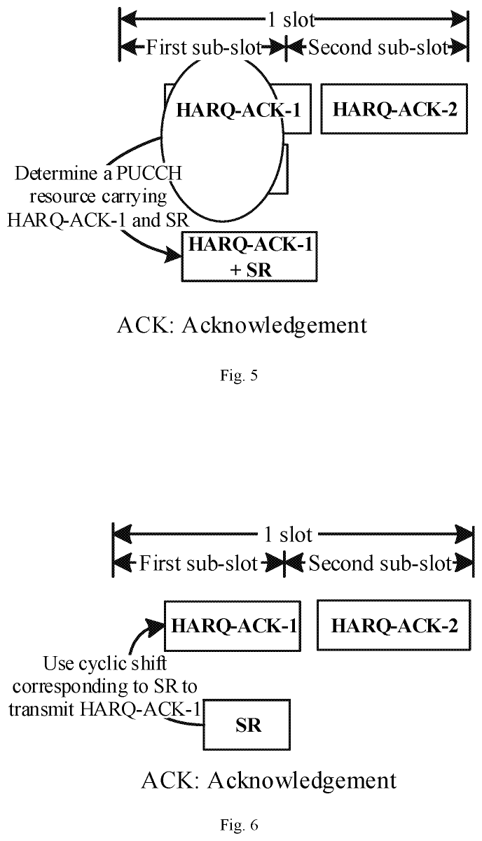

When the PUCCH carrying the HARQ-ACK adopts a PUCCH format 2/3/4, specifically as shown in FIG. 5, a PUCCH resource set is determined according to the total quantity of bits of the SR and the HARQ-ACK. According to a PUCCH resource indication field in DCI corresponding to the HARQ-ACK, a PUCCH resource for simultaneous transmission of the HARQ-ACK and the SR is determined in the determined PUCCH resource set. The resource may be the same as or different from an original HARQ-ACK resource. If the resource is the same as the original HARQ-ACK resource, the PUCCH finally carrying the SR and the HARQ-ACK does not cross the boundary of the sub-slot, and will not overlap with a PUCCH of HARQ-ACK-2, so multiplexing transmission of two HARQ-ACKs which do not originally overlap will not be caused. If the resource is different from the original HARQ-ACK resource, by limiting the resource to be contained in a sub-slot where original transmission of HARQ-ACK-1 is located, i.e. the first sub-slot, an overlap with the PUCCH of the HARQ-ACK-2 is avoided as well, so multiplexing transmission of the two HARQ-ACKs which do not originally overlap will not be caused.

When the PUCCH carrying the HARQ-ACK uses a PUCCH format 0, the multiplexing transmission mechanism is shown as FIG. 6. When positive SR exists, the HARQ-ACK is sent on the PUCCH resource corresponding to the HARQ-ACK by adopting a cyclic shift corresponding to the positive SR, so simultaneous existence of positive SR transmission is implicitly expressed, and the PUCCH finally carrying the SR and the HARQ-ACK is the original PUCCH corresponding to the HARQ-ACK-1 and will not cross the boundary of the sub-slot. Therefore, the PUCCH will not overlap with the PUCCH of the HARQ-ACK-2, and multiplexing transmission of the two HARQ-ACKs which do not originally overlap will not be caused.

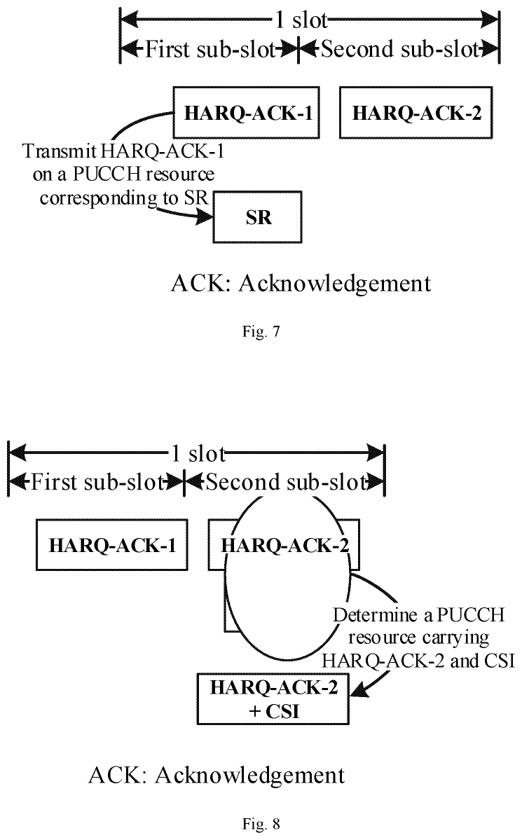

When both the PUCCH carrying the HARQ-ACK and the PUCCH carrying the SR adopt a PUCCH format 1, the multiplexing transmission mechanism is shown as FIG. 7. When positive SR exists, the HARQ-ACK is sent on the PUCCH resource corresponding to the SR, simultaneous existence of positive SR transmission is implicitly expressed by using the resource of the SR for transmission, and the PUCCH finally carrying the SR and the HARQ-ACK-1 is the PUCCH corresponding to the SR and will not cross the boundary of the sub-slot. Therefore, the PUCCH will not overlap with the PUCCH of the HARQ-ACK-2, and multiplexing transmission of the two HARQ-ACKs which do not originally overlap will not be caused.

In the second sub-slot, the CSI overlaps with the HARQ-ACK in time domain resource, and a multiplexing transmission mechanism is adopted as below.

When PUCCH resource sets are configured, and the HARQ-ACK is a t HARQ-ACK for downlink transmission with corresponding DCI, regardless of whether the PUCCH adopts the PUCCH format 2/3/4 or format 0/1, the multiplexing transmission mechanism is shown as FIG. 8. A PUCCH resource set is determined according to the total quantity of bits of the CSI and the HARQ-ACK-2. According to a PUCCH resource indication field in the DCI corresponding to the HARQ-ACK-2, one PUCCH resource for simultaneously transmitting the HARQ-ACK-2 and the CSI is determined in the selected PUCCH resource set. This one PUCCH resource may be the same as or different from the original HARQ-ACK-2 resource. If the resource is the same as the original HARQ-ACK-2 resource, the PUCCH finally carrying the CSI and the HARQ-ACK-2 will not cross the boundary of the sub-slot, and will not overlap with the PUCCH of the HARQ-ACK-1, so multiplexing transmission of two HARQ-ACKs which do not originally overlap will not be caused. If the resource is different from the original HARQ-ACK-2 resource, by limiting the resource to be contained in a sub-slot where original transmission of HARQ-ACK-2 is located, i.e. the second sub-slot, an overlap with the PUCCH of the HARQ-ACK-1 is avoided as well, so multiplexing transmission of the two HARQ-ACKs which do not originally overlap will not be caused.

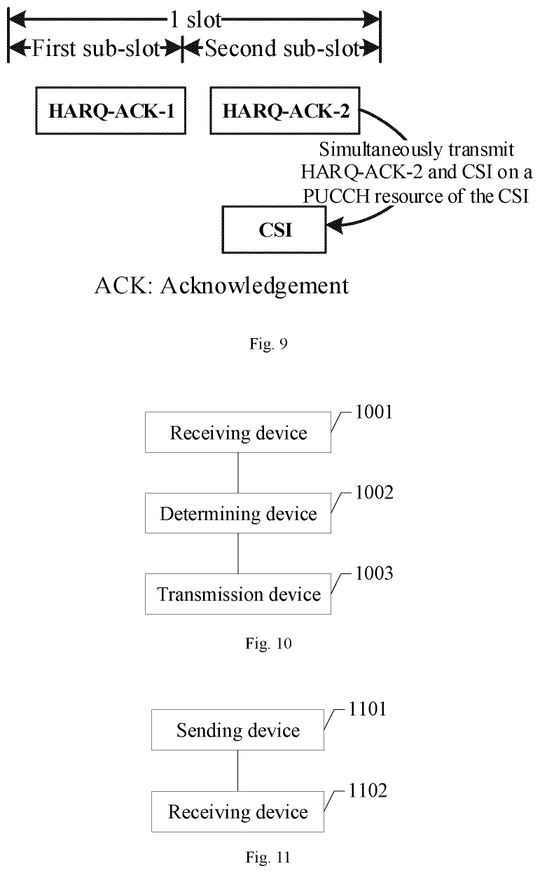

When the HARQ-ACK is HARQ-ACK corresponding to SPS PDSCH, the HARQ-ACK is simultaneously sent together with the CSI on the PUCCH resource corresponding to the CSI, and the multiplexing transmission mechanism is shown as FIG. 9. The PUCCH resource finally carrying the CSI and the HARQ-ACK-2 is a PUCCH resource corresponding to the CSI and will not cross the boundary of the sub-slot. Therefore, the PUCCH will not overlap with the PUCCH of the HARQ-ACK-1, and multiplexing transmission of the two HARQ-ACKs which do not originally overlap will not be caused.

A terminal side determines multiplexing transmission resources according to the above method, so the UCI is sent on corresponding resources in the first sub-slot and the second sub-slot; and a base station side determines multiplexing transmission resources according to the above method, so the UCI is received on corresponding resources in the first sub-slot and the second sub-slot.

It should be noted that, the above slot being divided into two sub-slots only serves an example. The slot may further be divided into other quantities of sub-slots and sub-slot lengths. For example, it may be divided into 7 sub-slots, each sub-slot containing 2 symbols, or be divided into 4 sub-slots, two of which each contain 3 symbols and two of which each contain 4 symbols, etc.

### Embodiment 5

FIG. 10 is a schematic structural diagram of a UCI transmission apparatus provided by an embodiment of the present disclosure. The apparatus includes: a receiving device 1001, configured to receive configuration information; a determining device 1002, configured to determine a PUCCH resource corresponding to UCI according to the configuration information, and the PUCCH resource is in one sub-slot; and a sending device 1003, configured to send the UCI according to the PUCCH resource corresponding to the UCI.

The configuration information is a high-level signaling, DCI, or MAC CE, and the UCI includes: at least one of HARQ-ACK, CSI or SR.

Further, the sub-slot is a pre-defined or configured time unit with a fixed quantity of symbols in a slot, and an order of sub-slots within the slot, a position of each sub-slot, and a quantity of symbols contained in each sub-slot are pre-defined or configured.

The quantities of symbols contained in different sub-slots within the slot are equal, or unequal.

Correspondingly, the PUCCH resource being in the sub-slot includes: the PUCCH resource does not cross a boundary of the sub-slot; or a start symbol and an end symbol of the PUCCH resource are in the same sub-slot; or a quantity of symbols of the PUCCH resource does not exceed the quantity of symbols contained in the sub-slot.

In the condition that different sub-slots contain different quantities of symbols, the quantity of the symbols of the PUCCH resource does not exceed the quantity of symbols contained in one sub-slot with the largest quantity of symbols.

In one embodiment, the sending device 1003 is further configured to send, in the condition that the PUCCH resource corresponding to the UCI does not overlap with other uplink channels in time domain, the UCI on the PUCCH resource corresponding to the UCI.

The sending device 1003 is further configured to determine, for any one sub-slot, in the condition that a PUCCH resource corresponding to first UCI in the any one sub-slot overlaps in at least one symbol with a PUCCH resource corresponding to second UCI, a PUCCH resource for sending the first UCI and the second UCI, and the PUCCH resource for sending the first UCI and the second UCI is in one sub-slot; and the first UCI and the second UCI are sent on the determined PUCCH resource.

### Embodiment 6

FIG. 11 is a schematic structural diagram of an apparatus for receiving UCI further provided by an embodiment of the present disclosure. The apparatus includes: a sending device 1101, configured to send configuration information, and the configuration information is configured to indicate a PUCCH resource corresponding to UCI and the PUCCH resource being in one sub-slot; and a receiving device 1102, configured to receive the UCI according to the PUCCH corresponding to the UCI.

The configuration information is a high-level signaling, DCI, or MAC CE, and the UCI includes: at least one of HARQ-ACK, CSI or SR.

Further, the sub-slot is a pre-defined or configured time unit with a fixed quantity of symbols in a slot, and an order of sub-slots within the slot, a position of each sub-slot, and the quantity of symbols contained in each sub-slot are pre-defined or configured.

The quantities of symbols contained in different sub-slots within the slot are equal, or unequal.

Correspondingly, the PUCCH resource being in the sub-slot includes: the PUCCH resource does not cross a boundary of the sub-slot; or a start symbol and an end symbol of the PUCCH resource are in the same sub-slot; or the quantity of symbols of the PUCCH resource does not exceed the quantity of symbols contained in the sub-slot.

In the condition that different sub-slots contain different quantities of symbols, the quantity of the symbols of the PUCCH resource does not exceed the quantity of symbols contained in one sub-slot with the largest quantity of symbols.

In one embodiment, the receiving device 1102 is further configured to receive, in the condition that the PUCCH resource corresponding to the UCI does not overlap with other uplink channels in time domain, the UCI on the PUCCH resource corresponding to the UCI.

The receiving device 1102 is further configured to determine, for any one sub-slot, in the condition that a PUCCH resource corresponding to first UCI in the any one sub-slot overlaps in at least one symbol with a PUCCH resource corresponding to second UCI, a PUCCH resource for receiving the first UCI and the second UCI, and the PUCCH resource for receiving the first UCI and the second UCI is in one sub-slot; and the first UCI and the second UCI are received on the determined PUCCH resource.

### Embodiment 7

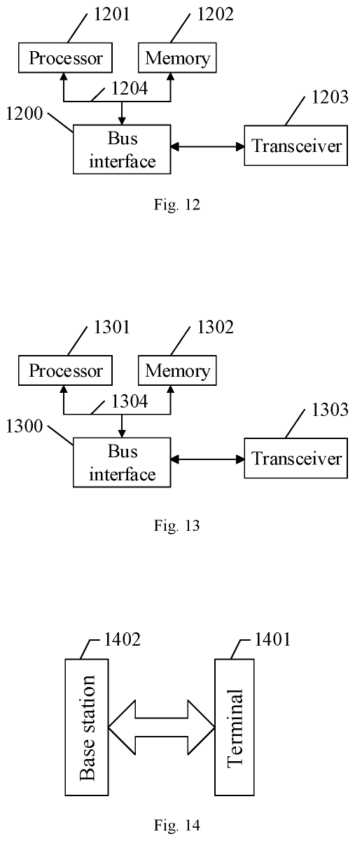

FIG. 12 is a schematic structural diagram of a terminal further provided by an embodiment of the present disclosure. The terminal includes: a processor 1201, a memory 1202, a transceiver 1203 and a bus interface 1200.

The processor 1201 is responsible for managing a bus architecture and general processing, and the memory 1202 may store data used by the processor 1201 when performing operations. The transceiver 1203 is configured to receive and send the data under control of the processor 1201.

The bus architecture may include any quantity of interconnected buses and bridges. Specifically, one or more processors represented by the processor 1201 and various circuits of a memory represented by the memory 1202 are linked together. The bus architecture may also link various other circuits such as peripheral devices, voltage regulators, power management circuits, etc. These are all known in the art, and therefore, no further description will be given herein. The bus interface provides an interface. The processor 1201 is responsible for managing the bus architecture and general processing, and the memory 1202 may store the data used by the processor 1201 when performing operations.

The processes disclosed in the embodiment of the present disclosure may be applied in the processor 1201 or implemented by the processor 1201. In an implementation process, each step of a signal processing flow may be completed by an integrated logic circuit of hardware in the processor 1201 or instructions in the form of software. The processor 1201 may be a general-purpose processor, a digital signal processor, an application specific integrated circuit, a field programmable gate array or other programmable logic device, a discrete gate or transistor logic device, or a discrete hardware component, and may implement or execute disclosed methods, steps and logic block diagrams in the embodiments of the present disclosure. The general-purpose processor may be a microprocessor or any conventional processor or the like. The steps of the methods disclosed in the embodiments of the present disclosure may be directly embodied as executed and completed by a hardware processor, or executed and completed by a combination of hardware and software modules in the processor. The software module may be located in a mature storage medium in the art, such as a random access memory, a flash memory, a read-only memory, a programmable read-only memory, an electrically erasable programmable memory, or a register. The storage medium is located in the memory 1202, and the processor 1201 reads information in the memory 1202, and completes the steps of the signal processing flow in combination with its hardware.

In one embodiment, the processor 1201 is configured to read a program in the memory 1202 to: receive configuration information; determine a PUCCH resource corresponding to UCI according to the configuration information, and the PUCCH resource is in one sub-slot; and send the UCI according to the PUCCH resource corresponding to the UCI.

The configuration information is a high-level signaling, DCI, or MAC CE, and the UCI includes: at least one of HARQ-ACK, CSI or SR.

The sub-slot is a pre-defined or configured time unit with a fixed quantity of symbols in a slot, and an order of sub-slots within the slot, a position of each sub-slot, and the quantity of symbols contained in each sub-slot are pre-defined or configured.

The quantities of symbols contained in different sub-slots within the slot are equal, or unequal.

Correspondingly, the PUCCH resource being in the sub-slot includes: the PUCCH resource does not cross a boundary of the sub-slot; or a start symbol and an end symbol of the PUCCH resource are in the same sub-slot; or the quantity of symbols of the PUCCH resource does not exceed the quantity of symbols contained in the sub-slot.

In the condition that different sub-slots contain different quantities of symbols, the quantity of the symbols of the PUCCH resource does not exceed the quantity of symbols contained in one sub-slot with the largest quantity of symbols.

In one embodiment, the sending the UCI according to the PUCCH resource corresponding to the UCI includes the following.

In the condition that the PUCCH resource corresponding to the UCI does not overlap with other uplink channels in time domain, the UCI is sent on the PUCCH resource corresponding to the UCI.

The sending the UCI according to the PUCCH resource corresponding to the UCI includes the following.

For any one sub-slot, in the condition that a PUCCH resource corresponding to first UCI in the any one sub-slot overlaps in at least one symbol with a PUCCH resource corresponding to second UCI, a PUCCH resource for sending the first UCI and the second UCI is determined, and the PUCCH resource for sending the first UCI and the second UCI is in one sub-slot; and the first UCI and the second UCI are sent on the determined PUCCH resource.

### Embodiment 8

FIG. 13 is a schematic structural diagram of a base station further provided by an embodiment of the present disclosure. The base station includes: a processor 1301, a memory 1302, and a transceiver 1303.

The processor 1301 is responsible for managing a bus architecture and general processing, and the memory 1302 may store data used by the processor 1301 when performing operations. The transceiver 1303 is configured to receive and send the data under control of the processor 1301.

The bus architecture may include any quantity of interconnected buses and bridges. In one embodiment, one or more processors represented by the processor 1301 and various circuits of a memory represented by the memory 1302 are linked together. The bus architecture may also link various other circuits such as peripheral devices, voltage regulators, power management circuits, etc. These are all known in the art, and therefore, no further description will be given herein. The bus interface provides an interface. The processor 1301 is responsible for managing the bus architecture and general processing, and the memory 1302 may store the data used by the processor 1301 when performing operations.

The processes disclosed in the embodiment of the present disclosure may be applied in the processor 1301 or implemented by the processor 1301. In an implementation process, each step of a signal processing flow may be completed by an integrated logic circuit of hardware in the processor 1301 or instructions in the form of software. The processor 1301 may be a general-purpose processor, a digital signal processor, an application specific integrated circuit, a field programmable gate array or other programmable logic device, a discrete gate or transistor logic device, or a discrete hardware component, and may implement or execute disclosed methods, steps and logic block diagrams in the embodiments of the present disclosure. The general-purpose processor may be a microprocessor or any conventional processor or the like. The steps of the methods disclosed in the embodiments of the present disclosure may be directly embodied as executed and completed by a hardware processor, or executed and completed by a combination of hardware and software modules in the processor. The software module may be located in a mature storage medium in the art, such as a random access memory, a flash memory, a read-only memory, a programmable read-only memory, an electrically erasable programmable memory, or a register. The storage medium is located in the memory 1302, and the processor 1301 reads information in the memory 1302, and completes the steps of the signal processing flow in combination with its hardware.

In one embodiment, the processor 1301 is configured to read a program in the memory 1302 to: send configuration information, and the configuration information is configured to indicate a PUCCH resource corresponding to UCI, and the PUCCH resource is in one sub-slot; and receive UCI according to the PUCCH resource corresponding to the UCI.

The configuration information is a high-level signaling, DCI, or MAC CE, and the UCI includes: at least one of HARQ-ACK, CSI or SR.

The sub-slot is a pre-defined or configured time unit with a fixed quantity of symbols in a slot, and an order of sub-slots within the slot, a position of each sub-slot, and the quantity of symbols contained in each sub-slot are pre-defined or configured.

The quantities of symbols contained in different sub-slots within the slot are equal, or unequal.

Correspondingly, the PUCCH resource being in the sub-slot includes: the PUCCH resource does not cross a boundary of the sub-slot; or a start symbol and an end symbol of the PUCCH resource are in the same sub-slot; or the quantity of symbols of the PUCCH resource does not exceed the quantity of symbols contained in the sub-slot.

In the condition that different sub-slots contain different quantities of symbols, the quantity of the symbols of the PUCCH resource does not exceed the quantity of symbols contained in one sub-slot with the largest quantity of symbols.

In one embodiment, the receiving the UCI according to the PUCCH resource corresponding to the UCI includes the following.

In the condition that the PUCCH resource corresponding to the UCI does not overlap with other uplink channels in time domain, the UCI is received on the PUCCH resource corresponding to the UCI.

The receiving the UCI according to the PUCCH resource corresponding to the UCI includes the following.

For any one sub-slot, in the condition that a PUCCH resource corresponding to first UCI in the any one sub-slot overlaps in at least one symbol with a PUCCH resource corresponding to second UCI, a PUCCH resource for receiving the first UCI and the second UCI is determined, and the PUCCH resource for receiving the first UCI and the second UCI is in one sub-slot; and the first UCI and the second UCI are received on the determined PUCCH resource.

### Embodiment 9

FIG. 14 is a UCI transmission system provided by an embodiment of the present disclosure. The system includes a terminal 1401 and a base station 1402.

The terminal 1401 is configured to receive configuration information; determine a PUCCH resource corresponding to UCI according to the configuration information, and the PUCCH resource is in one sub-slot; and send the UCI according to the PUCCH resource corresponding to the UCI.

The base station 1402 is configured to send the configuration information, and the configuration information is configured to indicate the PUCCH resource corresponding to the UCI and the PUCCH resource is in one sub-slot; and receive the UCI according to the PUCCH resource corresponding to the UCI.

Further, the configuration information is a high-level signaling, DCI, or MAC CE, and the UCI includes: at least one of HARQ-ACK, CSI or SR.

The sub-slot is a pre-defined or configured time unit with a fixed quantity of symbols in a slot, and an order of sub-slots within the slot, a position of each sub-slot, and the quantity of symbols contained in each sub-slot are pre-defined or configured.

The quantities of symbols contained in different sub-slots within the slot are equal, or unequal.

Correspondingly, the PUCCH resource being in the sub-slot includes: the PUCCH resource does not cross a boundary of the sub-slot; or a start symbol and an end symbol of the PUCCH resource are in the same sub-slot; or the quantity of symbols of the PUCCH resource does not exceed the quantity of symbols contained in the sub-slot.

In the condition that different sub-slots contain different quantities of symbols, the quantity of the symbols of the PUCCH resource does not exceed the quantity of symbols contained in one sub-slot with the largest quantity of symbols.

In one embodiment, the sending the UCI according to the PUCCH resource corresponding to the UCI includes the following.

In the condition that the PUCCH resource corresponding to the UCI does not overlap with other uplink channels in time domain, the UCI is sent on the PUCCH resource corresponding to the UCI.

The sending the UCI according to the PUCCH resource corresponding to the UCI includes the following.

For any one sub-slot, in the condition that a PUCCH resource corresponding to first UCI in the any one sub-slot overlaps in at least one symbol with a PUCCH resource corresponding to second UCI, a PUCCH resource for sending the first UCI and the second UCI is determined, and the PUCCH resource for sending the first UCI and the second UCI is in one sub-slot; and the first UCI and the second UCI are sent on the determined PUCCH resource.

In one embodiment, the receiving the UCI according to the PUCCH resource corresponding to the UCI includes the following.

In the condition that the PUCCH resource corresponding to the UCI does not overlap with other uplink channels in time domain, the UCI is received on the PUCCH resource corresponding to the UCI.

The receiving the UCI according to the PUCCH resource corresponding to the UCI includes the following.

For any one sub-slot, in the condition that a PUCCH resource corresponding to first UCI in the any one sub-slot overlaps in at least one symbol with a PUCCH resource corresponding to second UCI, a PUCCH resource for receiving the first UCI and the second UCI is determined, and the PUCCH resource for receiving the first UCI and the second UCI is in one sub-slot; and the first UCI and the second UCI are received on the determined PUCCH resource.

### Embodiment 10

According to the above embodiments, an embodiment of the present disclosure further provides a computer readable storage medium. The computer readable storage medium stores a computer program executable by a terminal, and when the program is run on the terminal, the terminal executes the following steps.

A memory stores the computer program, and when the program is executed by a processor, the processor executes the following steps.

Configuration information is received.

A PUCCH resource corresponding to UCI is determined according to the configuration information, and the PUCCH resource is in one sub-slot.

The UCI is sent according to the PUCCH resource corresponding to the UCI.

Further, the configuration information is a high-level signaling, DCI, or MAC CE, and the UCI includes: at least one of HARQ-ACK, CSI or SR.

The sub-slot is a pre-defined or configured time unit with a fixed quantity of symbols in a slot, and an order of sub-slots within the slot, a position of each sub-slot, and the quantity of symbols contained in each sub-slot are pre-defined or configured.

The quantities of symbols contained in different sub-slots within the slot are equal, or unequal.

Correspondingly, the PUCCH resource being in the sub-slot includes: the PUCCH resource does not cross a boundary of the sub-slot; or a start symbol and an end symbol of the PUCCH resource are in the same sub-slot; or the quantity of symbols of the PUCCH resource does not exceed the quantity of symbols contained in the sub-slot.

In the condition that different sub-slots contain different quantities of symbols, the quantity of the symbols of the PUCCH resource does not exceed the quantity of symbols contained in one sub-slot with the largest quantity of symbols.

In one embodiment, the sending the UCI according to the PUCCH resource corresponding to the UCI includes the following.

In the condition that the PUCCH resource corresponding to the UCI does not overlap with other uplink channels in time domain, the UCI is sent on the PUCCH resource corresponding to the UCI.

The sending the UCI according to the PUCCH resource corresponding to the UCI includes the following.

For any one sub-slot, in the condition that a PUCCH resource corresponding to first UCI in the any one sub-slot overlaps in at least one symbol with a PUCCH resource corresponding to second UCI, a PUCCH resource for sending the first UCI and the second UCI is determined, and the PUCCH resource for sending the first UCI and the second UCI is in one sub-slot; and the first UCI and the second UCI are sent on the determined PUCCH resource.

### Embodiment 11

According to the above embodiments, an embodiment of the present disclosure further provides a computer readable storage medium. The computer readable storage medium stores a computer program executable by a base station, and when the program is run on the base station, the base station executes the following steps.

A memory stores the computer program, and when the program is executed by a processor, the processor executes the following steps.

Configuration information is sent, and the configuration information is configured to indicate a PUCCH resource corresponding to UCI, and the PUCCH resource is in one sub-slot.

The UCI is received according to the PUCCH resource corresponding to the UCI.

Further, the configuration information is a high-level signaling, DCI, or MAC CE, and the UCI includes: at least one of HARQ-ACK, CSI or SR.

The sub-slot is a pre-defined or configured time unit with a fixed quantity of symbols in a slot, and an order of sub-slots within the slot, a position of each sub-slot, and the quantity of symbols contained in each sub-slot are pre-defined or configured.

The quantities of symbols contained in different sub-slots within the slot are equal, or unequal.

Correspondingly, the PUCCH resource being in the sub-slot includes: the PUCCH resource does not cross a boundary of the sub-slot; or a start symbol and an end symbol of the PUCCH resource are in the same sub-slot; or the quantity of symbols of the PUCCH resource does not exceed the quantity of symbols contained in the sub-slot.

In the condition that different sub-slots contain different quantities of symbols, the quantity of the symbols of the PUCCH resource does not exceed the quantity of symbols contained in one sub-slot with the largest quantity of symbols.

In one embodiment, the receiving the UCI according to the PUCCH resource corresponding to the UCI includes the following.

In the condition that the PUCCH resource corresponding to the UCI does not overlap with other uplink channels in time domain, the UCI is received on the PUCCH resource corresponding to the UCI.

The receiving the UCI according to the PUCCH resource corresponding to the UCI includes the following.

For any one sub-slot, in the condition that a PUCCH resource corresponding to first UCI in the any one sub-slot overlaps in at least one symbol with a PUCCH resource corresponding to second UCI, a PUCCH resource for receiving the first UCI and the second UCI is determined, and the PUCCH resource for receiving the first UCI and the second UCI is in one sub-slot; and the first UCI and the second UCI are received on the determined PUCCH resource.

The above-mentioned computer readable storage medium may be any available medium or data storage device that may be accessed by a processor in an electronic device, including but not limited to magnetic memories such as a floppy disk, a hard disk, a magnetic tape, a magneto-optical disk (MO), etc., optical memories such as a CD, a DVD, a BD, a HVD, etc., and semiconductor memories such as a ROM, an EPROM, an EEPROM, a non-volatile memory (NAND FLASH), a solid state drive (SSD), etc.

As for the system/device embodiments, since it is basically similar to the method embodiments, the description is relatively simple, and for related parts, please refer to the part of the description of the method embodiments.

It should be noted that relational terms such as first and second here are only used to distinguish one entity or operation from another entity or operation, and do not necessarily require or imply that any actual relationship or order exits between these entities or operations.

The embodiments of the present application can be provided as a method, a system, or a computer program product. Therefore, the present application may adopt the form of a complete hardware embodiment, a complete application embodiment, or an embodiment combining applications and hardware. Moreover, the present application may adopt the form of a computer program product implemented on one or more computer-usable storage media (including but not limited to a disk memory, a CD-ROM, an optical storage, etc.) containing computer-usable program codes.

The present disclosure is described with reference to flowcharts and/or block diagrams of methods, devices (systems), and computer program products according to embodiments of the present disclosure. It should be understood that each process and/or block in the flowcharts and/or block diagrams, and a combination of processes and/or blocks in the flowcharts and/or block diagrams may be realized by computer program instructions. These computer program instructions may be provided to a processor of a general-purpose computer, a special-purpose computer, an embedded processor, or other programmable data processing devices to generate a machine, and a device that realizes functions specified in one process or multiple processes in the flowcharts and/or one block or multiple blocks in the block diagrams is generated through the instructions executed by the processor of the computer or other programmable data processing devices.

These computer program instructions may also be stored in a computer readable memory that can guide the computer or other programmable data processing devices to work in a specific manner, and the instructions stored in the computer readable memory generate an article of manufacture including an instruction apparatus. The instruction apparatus realizes the functions specified in one process or multiple processes in the flowcharts and/or one block or multiple blocks in the block diagrams.

These computer program instructions may also be loaded on the computer or other programmable data processing devices, and a series of operation steps are executed on the computer or other programmable devices to produce computer-implemented processing, and the instructions executed on the computer or other programmable data processing devices provide steps for realizing the functions specified in one process or multiple processes in the flowcharts and/or one block or multiple blocks in the block diagrams.

1. A method for sending uplink control information (UCI), comprising:
receiving, by a terminal, configuration information;
determining, by the terminal, according to the configuration information, a physical uplink control channel (PUCCH) resource corresponding to UCI, wherein the PUCCH resource is in one sub-slot; and
sending, by the terminal, the UCI according to the PUCCH resource corresponding to the UCI.

2. The method according to claim 1, wherein the configuration information is a high-layer signaling, downlink control information (DCI), or a media access control (MAC) control element (CE); and/or
the UCI comprises: at least one of hybrid automatic repeat request-acknowledgement (HARQ-ACK), channel state information (CSI) or a scheduling request (SR); and/or
the one sub-slot is a pre-defined or configured time unit with a fixed quantity of symbols in one slot, and an order of sub-slots within the one slot, a position of each sub-slot, and a quantity of symbols contained in each sub-slot are pre-defined or configured.

3-5. (canceled)

6. The method according to claim 1, wherein the PUCCH resource being in one sub-slot comprises:
the PUCCH resource does not cross a boundary of one sub-slot; or
a start symbol and an end symbol of the PUCCH resource are in one same sub-slot; or
a quantity of symbols of the PUCCH resource does not exceed a quantity of symbols contained in one sub-slot.

7. The method according to claim 6, wherein in a condition that different sub-slots contain different quantities of symbols, the quantity of the symbols of the PUCCH resource does not exceed a quantity of symbols contained in a sub-slot with a largest quantity of symbols.

8. The method according to claim 1, wherein the sending the UCI according to the PUCCH resource corresponding to the UCI comprises:
sending, in a condition that the PUCCH resource corresponding to the UCI does not overlap with other uplink channels in time domain, the UCI on the PUCCH resource corresponding to the UCI; and/or
determining, for any one sub-slot, in a condition that at least one symbol of a PUCCH resource corresponding to first UCI in the any one sub-slot overlaps with a PUCCH resource corresponding to second UCI, a PUCCH resource for sending the first UCI and the second UCI, wherein the PUCCH resource for sending the first UCI and the second UCI is in the any one sub-slot and sending the first UCI and the second UCI on the determined PUCCH resource.

9. (canceled)

10. A method for receiving uplink control information (UCI), comprising:
sending, by a base station, configuration information, wherein the configuration information is configured to indicate a physical uplink control channel (PUCCH) resource corresponding to UCI, and the PUCCH resource is in one sub-slot; and
receiving, by the base station, the UCI according to the PUCCH resource corresponding to the UCI.

11. The method according to claim 10, wherein the configuration information is a high-layer signaling, downlink control information (DCI), or a media access control (MAC) control element (CE); and/or
the UCI comprises: at least one of hybrid automatic repeat request-acknowledgement (HARQ-ACK), channel state information (CSI) or a scheduling request (SR); and/or
the one sub-slot is a pre-defined or configured time unit with a fixed quantity of symbols in one slot, and an order of sub-slots within the one slot, a position of each sub-slot, and a quantity of symbols contained in each sub-slot are pre-defined or configured.

12-14. (canceled)

15. The method according to claim 10, wherein the PUCCH resource being in one sub-slot comprises:
the PUCCH resource does not cross a boundary of one sub-slot; or
a start symbol and an end symbol of the PUCCH resource are in one same sub-slot; or
a quantity of symbols of the PUCCH resource does not exceed a quantity of symbols contained in one sub-slot.

16. The method according to claim 15, wherein in a condition that different sub-slots contain different quantities of symbols, the quantity of the symbols of the PUCCH resource does not exceed a quantity of symbols contained in a sub-slot with a largest quantity of symbols.

17. The method according to claim 10, wherein the receiving the UCI according to the PUCCH resource corresponding to the UCI comprises:
receiving, in a condition that the PUCCH resource corresponding to the UCI does not overlap with other uplink channels in time domain, the UCI on the PUCCH resource corresponding to the UCI; and/or
determining, for any one sub-slot, in a condition that at least one symbol of a PUCCH resource corresponding to first UCI in the any one sub-slot overlaps with a PUCCH resource corresponding to second UCI, a PUCCH resource for receiving the first UCI and the second UCI, wherein the PUCCH resource for receiving the first UCI and the second UCI is in the any one sub-slot and receiving the first UCI and the second UCI on the determined PUCCH resource.

18-20. (canceled)

21. A terminal, comprising: a processor, a memory and a transceiver, wherein
the transceiver is configured to receive configuration information;
the processor is configured to read a program in the memory to: determine, according to the configuration information, a physical uplink control channel (PUCCH) resource corresponding to uplink control information (UCI), wherein the PUCCH resource is in one sub-slot; and control the transceiver to send the UCI according to the PUCCH resource corresponding to the UCI; and
the transceiver is further configured to send the UCI according to the PUCCH resource corresponding to the UCI.

22. The terminal according to claim 21, wherein the configuration information is a high-layer signaling, downlink control information (DCI), or a media access control (MAC) control element (CE); and/or
the UCI comprises: at least one of hybrid automatic repeat request-acknowledgement (HARQ-ACK), channel state information (CSI) or a scheduling request (SR); and/or
the one sub-slot is a pre-defined or configured time unit with a fixed quantity of symbols in one slot, and an order of sub-slots within the slot, a position of each sub-slot, and a quantity of symbols contained in each sub-slot are pre-defined or configured.

23-25. (canceled)

26. The terminal according to claim 21, wherein the PUCCH resource being in the one sub-slot comprises:
the PUCCH resource does not cross a boundary of one sub-slot; or
a start symbol and an end symbol of the PUCCH resource are in one same sub-slot; or
a quantity of symbols of the PUCCH resource does not exceed a quantity of symbols contained in one sub-slot.

27. The terminal according to claim 26, wherein in a condition that different sub-slots contain different quantities of symbols, the quantity of the symbols of the PUCCH resource does not exceed a quantity of symbols contained in a sub-slot with a largest quantity of symbols.

28. The terminal according to claim 21, wherein the processor is further configured to control, in a condition that the PUCCH resource corresponding to the UCI does not overlap with other uplink channels in time domain, control the transceiver to send the UCI according to the PUCCH resource corresponding to the UCI; and/or
the processor is further configured to determine, for any one sub-slot, in a condition that at least one symbol of a PUCCH resource corresponding to first UCI in the any one sub-slot overlaps with a PUCCH resource corresponding to second UCI, a PUCCH resource for sending the first UCI and the second UCI, wherein the PUCCH resource for sending the first UCI and the second UCI is in the any one sub-slot and control the transceiver to send the first UCI and the second UCI on the determined PUCCH resource.

29. (canceled)

30. A base station, comprising: a processor, a memory and a transceiver, wherein
the processor is configured to read a program in the memory to control the transceiver to perform the method according to claim 10.

31. The base station according to claim 30, wherein the configuration information is a high-layer signaling, downlink control information (DCI), or a media access control (MAC) control element (CE); and/or
the UCI comprises: at least one of hybrid automatic repeat request-acknowledgement (HARQ-ACK), channel state information (CSI) or a scheduling request (SR); and/or
the one sub-slot is a pre-defined or configured time unit with a fixed quantity of symbols in one slot, and an order of sub-slots within the slot, a position of each sub-slot, and a quantity of symbols contained in each sub-slot are pre-defined or configured.

32-34. (canceled)

35. The base station according to claim 30, the PUCCH resource being in the one sub-slot comprises:
the PUCCH resource does not cross a boundary of one sub-slot; or
a start symbol and an end symbol of the PUCCH resource are in one same sub-slot; or
a quantity of symbols of the PUCCH resource does not exceed a quantity of symbols contained in one sub-slot.

36. The base station according to claim 35, in a condition that different sub-slots contain different quantities of symbols, the quantity of the symbols of the PUCCH resource does not exceed a quantity of symbols contained in a sub-slot with a largest quantity of symbols.

37. The base station according to claim 30, wherein the processor is further configured to control, in a condition that the PUCCH resource corresponding to the UCI does not overlap with other uplink channels in time domain, the transceiver to receive the UCI according to the PUCCH resource corresponding to the UCI; and/or
the processor is further configured to determine, for any one sub-slot, in a condition that at least one symbol of a PUCCH resource corresponding to first UCI in the any one sub-slot overlaps in at least one symbol with a PUCCH resource corresponding to second UCI, a PUCCH resource for receiving the first UCI and the second UCI, wherein the PUCCH resource for receiving the first UCI and the second UCI is in the any one sub-slot; and control the transceiver to receive the first UCI and the second UCI on the determined PUCCH resource.

38-41. (canceled)
